(19) United States
(12) Patent Application Publication
(10) Pub. No.: US 2001/0017071 A1
(43) Pub. Date: Aug. 30, 2001

(54) METHOD AND ARRANGEMENT FOR REMOVING DUST IN CONNECTION WITH A SHEET CUTTER OF A PULP DRYING MACHINE OR EQUIVALENT

(76) Inventors: JENS PETTER ENKVIST, KENNEBANK, ME (US); JAN LINDSTROM, NAANTALI (FI); LARS HAKAN MIKAEL HANNUS, TURKU (FI); RAMI AALTONEN, TURKU (FI); JUHA LEIMU, TURKU (FI)

Correspondence Address: STEINBERG & RASKIN P C, 1140 AVENUE OF THE AMERICAS, NEW YORK, NY, 10036

(21) Appl. No.: 09/302,942

(22) Filed: Apr. 30, 1999

Related U.S. Application Data
(63) Continuation of application No. PCT/FI97/00661, filed on Oct. 29, 1997.

(30) Foreign Application Priority Data
Nov. 1, 1996 (FI) 964403

(51) Int. Cl. B26D 7/18

(52) U.S. Cl. 83/23; 83/100

(57) ABSTRACT

Method and arrangement for removing dust in connection with the sheet cutter of a pulp drying machine or equivalent in which a pulp web is slit in a slitter unit into longitudinal component webs. The longitudinal component webs are further cut in a cutter unit in the cross direction into sheets. Dust formed in connection with the slitter unit and/or the cutter unit in the sheet cutter is removed by at least two dust removing devices placed in the vicinity of the slitter unit and/or the cutter unit.

### CROSS-REFERENCE TO RELATED APPLICATION

This application is a continuation of International Application PCT/FI97/00661 filed Oct. 29, 1997.

### FIELD OF THE INVENTION

The present invention relates to a method for removing dust in connection with a sheet cutter of a pulp drying machine or equivalent, in which the pulp web is slit in a slitter unit into longitudinal component webs and the longitudinal component webs are further cut in a cutter unit in the cross direction into sheets and this cutting is carried out preferably inside an encapsulated space.

The present invention also relates to a sheet cutter of a pulp drying machine or equivalent including a slitter unit, a cutter unit, control units for conveying the pulp web and an arrangement for removing dust formed during the slitting of the web in the slitter unit and/or during the cutting of the web in the cutter unit.

### BACKGROUND OF THE INVENTION

In a sheet cutter for pulp, in slitting and cutting, a considerable amount of dust is produced. In the sheet cutter and in the following sheet baling press, the dust thus-produced is susceptible to causing various problems. The dust causes, for example, problems of runnability, such as web breaks, which arise from disturbance in the operation of photocells and the bale press. Further, clods of dust may cause increased and prolonged servicing and maintenance standstills. Also, dust may cause a risk of fire and explosion and, of course, it also causes contamination of the working environment and impurity of the air for breathing. Thus, in a sheet cutter for pulp, dust removing devices are needed to eliminate these problems.

To this end, as is well known in the art, attempts are made to encapsulate the sheet cutter. The reasons for this encapsulation are: 1) attenuation of noise; b) restricting of the dust problems; and 3) isolation of the revolving blade part out of reasons of work-safety.

With respect to the prior art, German Patent Publication No. DE 44 25 666 describes a cutting arrangement provided with a dust removing device located in the vicinity of a cutting unit. The cutting unit cuts the webs longitudinally and the dust subsequently generated is drawn away by the dust removing device. The dust removing device comprises two dust removing elements located under the cutting point.

International Publication No. WO 93/23315 descries a machine for cutting a paper web into sheets with simultaneous cutting of a transverse strip. The strips are removed by suction up into a groove which communications via a channel system connected with a vacuum source and a compressed air source, before they arrive at the subsequent production steps and cause damage. A suction funnel is arranged in the vicinity of a knife cylinder of the cutting device and is connected with a vacuum source via a channel.

### OBJECTS AND SUMMARY OF THE INVENTION

An object of the present invention is to suggest a solution for the problems described above.

Another object of the present invention is to provide an arrangement and method for removing dust from a sheet cutter of a pulp drying machine and equivalent in which the dust is removed at least one optimal location and/or by means of at least one optimal quantity of air.

Another object of the present invention is to provide a new and improved dust removing arrangement for a sheet cutter of a pulp drying machine and equivalent constructed such that it does not cause further problems around the sheet cutter, i.e., it does not cause dust clods to fall onto the web, blockage of the constructions, or disturbances in the operation of the blades in the sheet cutter.

Still another object of the present invention is to provide new and improved methods and arrangement for removing dust from a sheet cutter of a pulp drying machine and new and improved sheet cutters of a pulp drying machine.

In view of achieving the objects stated above and others, in the method in accordance with the invention, dust that is formed in connection with the slitter unit and/or with the cutter unit in the sheet cutter is removed by means of at least two dust removing devices placed substantially in the vicinity of the slitter unit and/or the cutter unit.

The arrangement in accordance with the invention comprises at least two dust removing devices, which are placed substantially in the vicinity of the slitter unit and/or the cutter unit. In the direction of progress of the pulp web, after the slitter unit, a following nip formed by a pair of rolls separates dust from the web and stops the dusty boundary-layer flow. Likewise, the nip formed by the pair of rolls following after the cutter unit separates dust from the web and stops the dusty boundary layer. Outlets are situated below the pairs of rolls following after the slitting and cutting so that the dust swirling in front of the nip can be removed.

By means of the method in accordance with the invention, efficient removal of dust is achieved in connection with the sheet cutter, whereby the problems caused by dust can be eliminated or at least minimized.

The dust removing devices used in the arrangement and method in accordance with the invention preferably extend substantially across at least the entire width of the web and are positioned in compliance with the constructions and placed at locations at which dust is formed, and their air quantity is optimized so that the removal of dust is efficient.

The dust that is formed during the slitting of the web moves along the face of the web in the direction of the web, and the dust removing devices used in connection with the slitting of the web in the sheet cutter are placed across the web so that the suction takes place at the locations where the concentration of dust is highest and before the dust is spread more widely. In connection with the cutting in the sheet cutter, an abundance of dust is formed, which swirls in the vicinity of the cutter unit, in which case, the dust removing devices are placed preferably at both sides of the web in direct vicinity of the cutting blades. In this manner, the dust is caught before it can be spread more widely.

In the arrangement in accordance with the invention, preferably a suction box is used as the dust removing device, to which suction box a vortex flow has been applied. The vortex flow prevents adherence of dust on the faces in the suction box. The suction box that is used may include one or several suction slots, through which the air that contains dust is sucked or drawn away from the vicinity of the source of dust. The dust suction box can be integrated in the frame or box constructions of the sheet cutter so that the beams that run in the cross direction of the cutter are suitably shaped for the purpose. The vortex suction boxes are also shaped and placed so that the suction flow flushes all the inside faces in the encapsulated area in the cutter and keeps these faces clean. In this manner, dead comers or equivalent shapes that gather dust do not remain in connection with the areas in which dust is formed.

In one exemplifying embodiment of the method for removing dust in connection with a sheet cutter of a pulp drying machine in accordance with the invention, the sheet cutter includes cutting means for slitting a pulp web into longitudinal component webs and cutting the longitudinal component webs in a cross direction into sheets whereby dust is formed in connection with the cutting means, and dust formed in connection with the cutting means is removed through at least two dust removing devices arranged proximate the cutting means. The cutting means usually include a slitter unit in which the web is slit into the longitudinal component webs and a cutter unit in which the longitudinal component webs are cut in the cross direction into sheets. The cutter also usually includes a first pair of rolls arranged after the slitter unit in a running direction of the web and a second pair of rolls arranged after the cutter unit in the running direction of the web. In this case, one dust removing device is arranged below the first pair of rolls and another is arranged below the second pair of rolls. If there are only two dust removing devices, one should be arranged proximate and above the cutter unit and the other proximate and below the cutter unit. If there are three dust removing devices, one may be arranged above the slitter unit and proximate and above the cutter unit, another proximate and below the slitter unit, and the last proximate and below the cutter unit.

In certain embodiments, a vortex is generated in one or more of the dust removing devices to thereby draw air from a vicinity of the dust removing device into the dust removing device and prevent adhering of dust to a face of the dust removing device. The dust removing devices thus constitute vortex suction boxes and may comprise a flow slot extending in a machine direction and screws for regulating a width of the flow slot in the machine direction to thereby provide a variable suction force in the cross-direction.

The total air quantity used in the dust removing devices may be regulated to be from about 0.1 to about 3.0 cubic meters per second per meter, or preferably from about 0.5 to about 1.0 cubic meters per second per meter.

Furthermore, one dust removing device may be arranged to remove dust from below the pulp web and also from above a broke conveyor situated below the sheet cutter. In this case, a space above a belt conveyor of the broke conveyor is preferably encapsulated and a curtain jet is employed in a vicinity of the belt of the broke conveyor.

A sheet cutter of a pulp drying machine including the arrangement in accordance with the invention includes cutting means for slitting a pulp web into longitudinal component webs and cutting the longitudinal component webs in a cross direction into sheets whereby dust is formed in connection with the cutting means and at least two dust removing devices arranged proximate the cutting means for removing dust formed in connection with the cutting means. The sheet cutter may include a dust exhaust system and duct means for coupling the dust removing devices to the dust exhaust system and/or a box construction at least partially surrounding all or part of the cutting means.

The invention will be described in detail with reference to some preferred embodiments of the invention illustrated in the figures in the accompanying drawings. However, the invention is not confined to the illustrated embodiments alone.

### BRIEF DESCRIPTION OF THE DRAWINGS

Additional objects of the invention will be apparent from the following description of the preferred embodiment thereof taken in conjunction with the accompanying non-limiting drawings, in which:

FIG. 1 is a schematic illustration of a sheet cutter of a pulp drying machine including the dust removing arrangement in accordance with the invention and in which the dust removing method in accordance with the invention can be applied; and

FIG. 2 is a schematic illustration of a vortex suction chamber for use in connection with the dust removing arrangement and method in accordance with the invention.

### DETAILED DESCRIPTION OF THE PREFERRED EMBODIMENTS

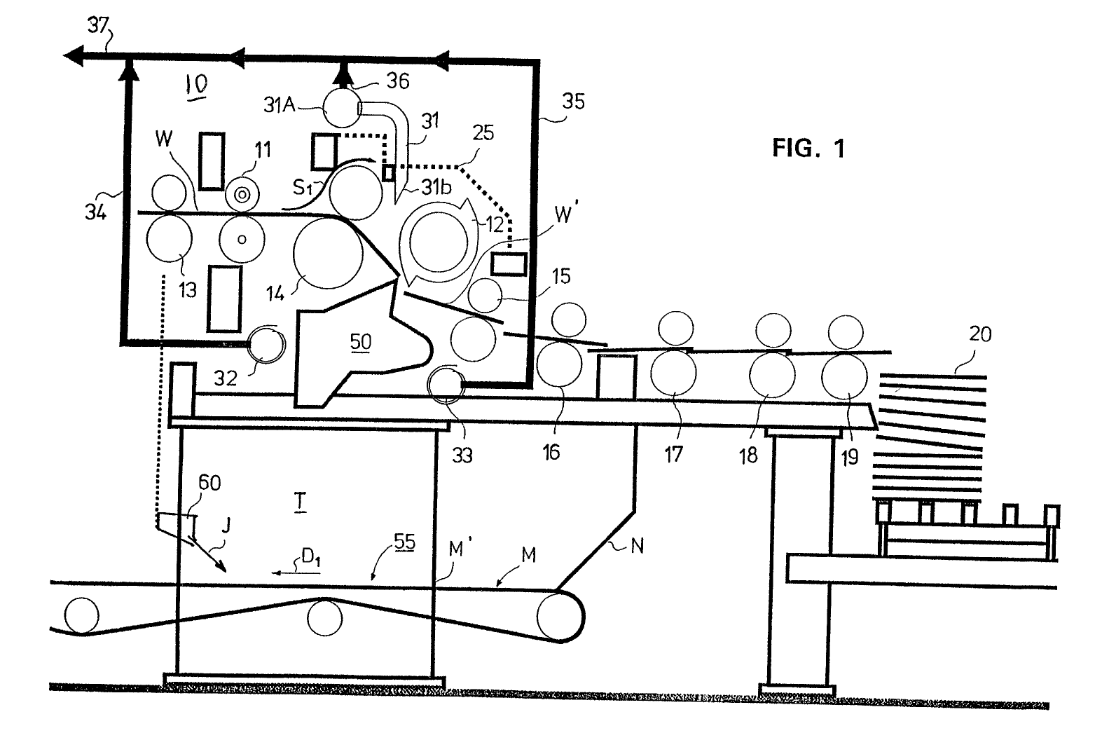

Referring to the accompanying drawings wherein like reference numerals refer to the same or similar elements, as shown in FIG. 1, a sheet cutter 10 in a pulp drying machine or pulp dryer comprises web cutting means, namely a slitter part or unit 11 and a cutter part or unit 12. A dried pulp web W is passed through a guide roll unit 13 into the slitter part 11 and in the slitter part 11, the pulp web W is slit into longitudinal component webs. After the slitter part 11, the pulp web passes into a drive roll unit 14 (a pair of nip-forming rolls), from which the pulp web W is passed into the cutter unit 12. In the cutter unit 12, the component webs are cut in the cross direction into sheets W′ having a desired length, the cutter unit 12 also being referred to as a cross-cutter unit. The sheets W′ are passed through guide roll units 15,16,17,18,19 to a bale press unit 20. Guide roll unit 15 is a pair of nip-forming rolls.

In the sheet cutter 10 of the pulp dryer, the cutter unit 12 is situated inside or encapsulated in a box construction 25, and the function of the box construction 25 is attenuation of noise and prevention of the spreading of dust as well as the prevention of accidents that may occur to the employees in connection with the revolving blades of the cutter unit 12.

In order that the dust formed in the slitter unit 11 and the cutter unit 12 should not deteriorate the runnability of the sheet cutter 10 or be carried along with the web W, dust removing devices 31,32,33 are arranged in the interior of the box construction 25. The box construction 25, which preferably encapsulates at least the cutter unit 12, extends to a location above the cutter unit 12 and the drive roll unit 14, and in its interior there is the dust removing device 31 which has a suction box or chamber 31 A and an orifice 31b of its exhaust pipe or equivalent opening in the direct vicinity of a cutter blade 12a of the cross-cutter unit 12 at its inlet side, as viewed in the direction of progress of the web. The dust removing device 31 extends substantially across the entire machine width. The dust formed in the slitter unit 11 moves on the web W face in the direction of the web and is carried into the area of the dust removing device 31, which thus also absorbs dust that has been formed in the slitter unit 11 (arrow S₁).

The second dust removing device 32 is arranged to have an opening below the pulp web 20 before a blade beam 50 as viewed in the running direction of the web. The third dust removing device 33 is arranged to have an opening below the cross-cutter unit 12 and below the pulp web W. By means of the third dust removing device 33, dust formed in connection with the cutting is drawn away, which dust swirls in the vicinity of the cutter unit 12. The dust removing devices 32,33, which may be suction beams or suction boxes, are situated below the following pair of rolls, as viewed in the direction of progress. From the dust removing devices 32,33 placed below the web W, the air that contains dust is passed along a system of ducts 34,35 to a dust collecting and exhaust duct 37. The dust removed from the dust removing device 31 is also passed to the dust exhaust duct 37, through a suction box or chamber 31A into a duct 36 and from duct 36 further into the dust exhaust duct 37. The air that contains dust is passed along the dust exhaust duct 37 into an air cleaning device or equivalent.

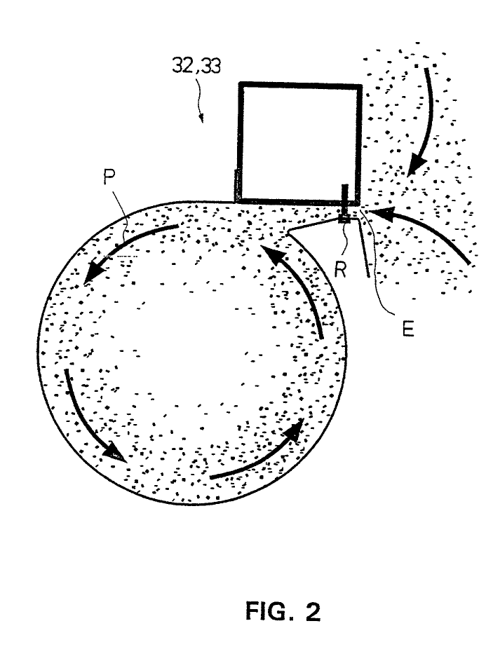

The dust removing devices 31,32,33 comprise one or several suction openings, which extend substantially across the entire width of the web W and remove the dust that is formed in connection with the slitting and cutting of the web. In the exemplifying embodiment shown in FIG. 1, the dust removing devices 32,33 placed below the web W comprise a vortex flow suction box, which is described in more detail in connection with the description related to FIG. 2, and the dust removing device 31 is a general dust remover by whose means dust is removed from the area above the web. The quantities of air that are used in the dust removing devices are optimized so that the dust formed in connection with the slitting and cutting can be sucked or drawn off efficiently from the areas of slitting and cutting and from the interior of the box construction 25 of the sheet cutter 10. The quantities of air used in each dust removing device may be:

dust removing device 31: about 0.05 to about 1.5 cu.m per second per meter;

dust removing device 32: about 0.05 to about 1.5 cu.m per second per meter; and

dust removing device 33: about 0.05 to about 1.5 cu.m per second per meter.

In connection with cross-direction cutting, it is also possible to employ a dust removing device fitted at one side only, for example, to omit the upper dust removing device when most of the dust is passed in the sheet cutter to below the cutter.

The dust removing device 32,33 may comprise a suction box as shown in FIG. 2, into which a vortex flow has been arranged. The vortex flow P produced in the suction box 32,33 prevents adhering and gathering of dust on the faces thereof. Such a vortex suction box 32,33 can be constructed as a unit of its own, or it can be integrated in the frame or box constructions of the sheet cutter 10 so that the beams passing across the cutter are shaped suitably for this purpose. Also, if necessary, the frame constructions of the cutter can be used as air ducts in the dust exhaust arrangement. The vortex suction boxes 32,33 are shaped and placed so that the air flow flushes all the inside faces in the encapsulated area of box construction 25 in the cutter and keeps them clean, such as, for example, in the arrangement as shown in FIG. 1.

In the construction shown in FIG. 2, a flow gap slot E can be regulated across the machine width by means of a screw device R. There are preferably several screws R situated over the length of the flow gap slot E. In such a case, the dust catching capacity of the suction boxes 32,33 can be regulated in any arbitrary way. For example, the catching capacity can be regulated to be invariable, or the suction in the lateral areas of the web can be enhanced or increased relative to a middle area.

Referring again to FIG. 1, below the pulp web, there is additionally a broke conveyor 55, preferably a belt conveyor. The running direction of the top run M′ of the belt M is denoted by arrow D₁. In the vicinity of the end of the belt M, a vertical second end wall N is arranged and the wall at the outlet side of the broke fall space T at the belt M is a curtain jet J, which is produced from a nozzle beam 60 through nozzle openings/slots/slot. The curtain jet J extends across substantially the entire machine width and belt width.

Thus, the broke fall space T is closed towards the environment and, thus, encapsulated. By means of the air jet, i.e., the so-called curtain jet J, passing of impurities and dust into the factory space is prevented. Thus, by means of the dust removing device 33, dust is also removed out of the broke fall space T and thus, detrimental carriage of dust into the environment is excluded. The curtain jet J at the conveyor 55 efficiently prevents carriage of dust along with the belt conveyor 44 in its run into the surrounding environment. The wall N and the curtain jet J together make the space T encapsulated.

The lower part of the cutter can also be carried into effect without encapsulation and without a related curtain blowing/blowings.

The examples provided above are not meant to be exclusive. Many other variations of the present invention would be obvious to those skilled in the art, and are contemplated to be within the scope of the appended claims. Thus, the invention has been described above only with reference to some of its advantageous embodiments. However, the invention is not intended to be narrowly confined to the disclosed embodiments. Numerous variations and modifications are possible within the scope of the inventive idea defined in the following claims.

We claim:

1. A method for removing dust in connection with a sheet cutter of a pulp drying machine including cutting means for slitting a pulp web into longitudinal component webs and cutting the longitudinal component webs in a cross direction into sheets whereby dust is formed in connection with the cutting means, the method comprising the step of:
removing dust formed in connection with the cutting means through at least two dust removing devices arranged proximate the cutting means.

2. The method of claim 1, wherein the cutting means include a slitter unit in which the web is slit into the longitudinal component webs and a cutter unit in which the longitudinal component webs are cut in the cross direction into sheets.

3. The method of claim 2, wherein the cutter includes a first pair of rolls arranged after the slitter unit in a running direction of the web and a second pair of rolls arranged after the cutter unit in the running direction of the web, further comprising the steps of:
arranging a first one of the at least two dust removing devices below the first pair of rolls, and
arranging a second one of the at least two dust removing devices below the second pair of rolls.

4. The method of claim 2, wherein the at least two dust removing devices comprises only two dust removing devices, further comprising the steps of:
arranging a first one of the two dust removing devices proximate and above the cutter unit, and
arranging a second one of the two dust removing devices proximate and below the cutter unit.

5. The method of claim 2, wherein the at least two dust removing devices comprises three dust removing devices, further comprising the steps of:
arranging a first one of the three dust removing devices above the slitter unit and proximate and above the cutter unit,
arranging a second one of the three dust removing devices proximate and below the slitter unit, and
arranging a third one of the three dust removing devices proximate and below the cutter unit.

6. The method of claim 1, wherein the step of removing dust comprises the step of:
generating a vortex in each of the at least two dust removing devices to thereby draw air from a vicinity of the dust removing device into the dust removing device and prevent adhering of dust to a face of the dust removing device.

7. The method of claim 1, further comprising the step of:
regulating the total air quantity used in the at least two dust removing devices to be from about 0.1 to about 3.0 cubic meters per second per meter.

8. The method of claim 1, further comprising the step of:
regulating the total air quantity used in the at least two dust removing devices to be from about 0.5 to about 1.0 cubic meters per second per meter.

9. The method of claim 1, further comprising the steps of:
arranging a first one of the at least two dust removing devices to remove dust from below the pulp web and from above a broke conveyor situated below the sheet cutter,
encapsulating a space above a belt conveyor of the broke conveyor, and
employing a curtain jet in a vicinity of the belt of the broke conveyor.

10. In a sheet cutter of p dying machine including cutting means for slitting a pulp web into longitudinal component webs and cutting the longitudinal component webs in a cross direction into sheets whereby dust is formed in connection with said cutting means, an arrangement for removing the dust formed in connection with said cutting means comprising:
at least two dust removing devices arranged proximate said cutting means for removing dust formed in connection with said cutting means.

11. The sheet cutter of claim 10, wherein said cutting means include a slitter unit in which the web is slit into the longitudinal component webs and a cutter unit in which the longitudinal component webs are cut in the cross direction into sheets.

12. The sheet cutter of claim 11, wherein said at least two dust removing devices comprises only two dust removing devices, a first one of said two dust removing devices being arranged proximate and above said cutter unit and a second one of said two dust removing devices being arranged proximate and below said cutter unit.

13. The sheet cutter of claim 11, wherein said at least two dust removing devices comprises three dust removing devices, a first one of said three dust removing devices being arranged above said slitter unit and above said cutter unit, a second one of said three dust removing devices being arranged proximate and below said slitter unit, and a third one of said three dust removing devices being arranged proximate and below said cutter unit.

14. The sheet cutter of claim 10, wherein said at least two dust removing devices are vortex suction boxes in which a vortex is generated,.

15. The sheet cutter of claim 14, wherein said vortex suction boxes comprise a flow slot extending in a machine direction and screws for regulating a width of said flow slot in the machine direction.

16. The sheet cutter of claim 10, further comprising a dust exhaust system and duct means for coupling said at least two dust removing devices to said dust exhaust system.

17. The sheet cutter of claim 11, further comprising a box construction at least partially surrounding said cutter unit.

18. The sheet cutter of claim 17, wherein one of said at least two dust removing devices defines a suction chamber exterior of said box construction and includes an exhaust pipe having an inlet orifice in an interior of said box construction and extending to said suction chamber.

19. The sheet cutter of claim 10, further comprising
a broke conveyor arranged below said cutting means,
a wall defining a broke fall space above said broke conveyor, and
means for directing a curtain jet at said broke conveyor to prevent removal of dust from said broke fall space,
one of said at least two dust removing device being arranged to remove dust from said broke fall space.

20. The sheet cutter of claim 11, further comprising
a first pair of rolls arranged after said slitter unit in a running direction of the web and through which the longitudinal component webs are adapted to pass, and
a second pair of rolls arranged after said cutter unit in the running direction of the web and through which the sheets are adapted to pass,
a first one of said at least two dust removing devices being arranged below said first pair of rolls, and
a second one of said at least two dust removing devices being arranged below said second pair of rolls.

21. The sheet cutter of claim 10, wherein a first one of said at least two dust removing devices is arranged above said cutting means and a second one of said at least two dust removing devices is arranged below said cutting means.
